(19) United States
(12) Patent Application Publication
(10) Pub. No.: US 2010/0138172 A1
(43) Pub. Date: Jun. 3, 2010

(54) GAS PRESSURE SPRING WITH MEASUREMENT MEANS AND DEVICE AND METHOD FOR MONITORING AT LEAST ONE PHYSICAL MEASUREMENT WHICH OCCURS INSIDE AND/OR AT A GAS PRESSURE SPRING

(75) Inventor: Norbert Reinmuth, Neckarmuehlbach (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: FIBRO GMBH, Hassmersheim (DE)

(21) Appl. No.: 12/596,811

(22) PCT Filed: May 30, 2008
(86) PCT No.: PCT/DE2008/000892

§ 371 Date: Oct. 20, 2009

(30) Foreign Application Priority Data
Jul. 20, 2007 (DE) 10 2007 034 416.5

(51) Int. Cl. G01L 19/00; G01M 3/04; G06F 19/00

(52) U.S. Cl. 702/50; 73/40; 702/130

(57) ABSTRACT

A gas pressure spring (1), in particular for absorbing stroke movements in a tool or in a machine, is designed and developed, with respect to the replicability and predictability of the behavior during use, as a function of the respective use conditions such that one or more measurement means for monitoring at least one physical measurement variable which occurs inside and/or at the gas pressure spring are provided. Furthermore, a device and a method for monitoring at least one physical measurement variable which occurs inside and/or at a gas pressure spring (1) are proposed.

The invention concerns a gas pressure spring, especially for absorbing stroke movements in a tool or machine. The invention also concerns a device and method for monitoring at least one physical measurement variable occurring in and/or on a gas pressure spring.

Gas pressure springs are pneumatic springs that use a pressurized gas to produce a spring force. The gas pressure spring then acts as a hydropneumatic adjustment element. Gas pressure springs generally consist of a pressure tube, a piston rod and a piston. The gas pressure spring is filled with a compressed gas. The gas exerts a force on the piston that is used as restoring force of the gas pressure spring. The restoring force can be precisely established by selecting an appropriate gas or gas mixture and adjusting the specific filling pressure.

The piston ordinarily has at least one small opening, through which the compressed gas can flow to the other side of the piston. Because of this, not only is a restoring force produced, but also a particularly advantageous damping effect of the gas pressure spring.

Such gas pressure springs are found, for example, in office chairs or as holding devices of trunk lids in vehicles.

Gas pressure springs of the type just mentioned are also used in order to produce both a restoring force and a certain damping effect in tools or machines. These can be machines that execute a continuously repeating stroke movement. Such a stroke movement is characterized by repeating back-and-forth movement of a moving component, in which the position of the two dead centers of the stroke movement generally does not change.

During such use in tools and machines, however, a change in spring and/or damping characteristic of a gas pressure spring can occur through external and/or internal effects. If the temperature of the spring increases, the internal pressure of the enclosed gas rises simultaneously. The spring characteristic is changed on this account. The viscosity of the enclosed fluid is also changed by mechanical stress and by the effect of temperature, so that a change in damping characteristic mostly occurs.

The aforementioned changes are not predictable in gas pressure springs according to the prior art. If a deterioration in damping and/or spring characteristic occurs, this cannot be attributed to a direct physical phenomenon in a known gas pressure spring. The user of the gas pressure spring is restricted to the use of empirically gained knowledge.

The task underlying the present invention is therefore to provide comprehensibility and predictability of the use behavior of gas pressure springs as a function of the corresponding use conditions.

This task is solved with reference to a gas pressure spring with the features of Claim 1. According to it, a gas pressure spring of the type just mentioned is modified and configured, so that one or more sensors are provided to monitor at least one physical measurement variable occurring within and/or on the gas pressure spring.

It was recognized according to the invention that monitoring of physical measurement variables within and/or on gas pressure springs permits precise analysis of the instantaneous use behavior. The use behavior established in the corresponding operating situation, i.e., especially the damping and spring characteristic of the gas pressure spring, can be attributed to instantaneously prevailing pressure and temperature conditions in the gas pressure spring. Thus, a correlation of the use behavior of the gas pressure spring with the current environmental conditions can always occur.

It is also possible for the user to predict the performance characteristics of the gas pressure spring as a function of certain environmental or use conditions by means of the measured physical parameters—especially pressure and/or temperature. An appropriate gas pressure spring can therefore be deliberately selected for the prescribed use purpose.

Finally, accidents or damage to the spring itself or to the machine containing the spring can be detected with the gas pressure spring according to the invention. For example, if the dead point of the stroke movement of the machine is adjusted, this can be directly established by means of a deviating pressure value within the gas pressure spring. Damage to the gas pressure spring itself (for example, a leak) can also be established by means of abnormal pressure or temperature values, even if the spring is not accessible or visible from the outside.

Consequently, a gas pressure spring is provided in which comprehensibility and predictability of the use behavior is achieved as a function of the corresponding use conditions.

The gas pressure spring according to the invention, with particular preference, has a pressure sensor or a combined pressure/temperature sensor. The gas spring can also have several pressure sensors and/or several pressure/temperature sensors. They can be distributed over the length of the gas pressure spring. It is also conceivable to provide a pressure sensor on each side of the piston. These pressure sensors then measure the internal pressure of the gas pressure spring, namely the pressure of the compressed fluid within the cylinder.

In another variant, the gas pressure spring, as an alternative or in addition to the mentioned pressure sensor, also has one or more temperature sensors. Such temperature sensors can record both the temperature of the surface of the gas pressure spring and the temperature of the compressed gas within the spring. Because of this, a correlation between the internal and external temperature of the gas pressure spring can be established with particular advantage.

In a particularly preferred modification, the sensors of the gas pressure spring have a power supply independent of line voltage. Cabling expense is eliminated on this account. The power supply can be furnished by batteries, storage batteries or even inductively.

In another embodiment, the sensors of the gas pressure spring have a memory for measured data. In this variant, an evaluation or display unit for the measured data can optionally be omitted. Stored measured values can be periodically or continuously queried and displayed.

With reference to a device for monitoring of at least one physical measurement variable occurring within and/or on a gas pressure spring, the aforementioned task is solved with the features of Claim 6. According to it, such a device according to the invention has:
one or more gas pressure springs according to the invention,
one or more evaluation units, and
one or more data transmission devices to transmit data between the sensors and the evaluation unit.

In the method according to the invention, the device permits monitoring of one or more physical measurement variables occurring within and/or on one or more gas pressure springs. For this purpose, use of a gas pressure spring according to the invention having at least one sensor is initially prescribed. The measured data are conveyed by means of one or more data transmission devices to one or more evaluation units. Display and additional processing of the data can be carried out directly in the evaluation unit or in additional optional devices.

Gapless monitoring of the use behavior of the gas pressure spring is implemented with the device according to the invention. The obtained measured values are also usable to permit comprehensibility and predictability of the use behavior of the gas pressure spring as a function of the corresponding use conditions.

The evaluation unit preferably has a microcontroller. A small size, low power demand and inexpensive preparation of the evaluation unit are made possible on this account.

With respect to the cheapest possible solution, the data transmission device can have one or more conductors, especially cables, and/or one or more coupled buses between the gas pressure spring and the evaluation unit. Individual linking of each individual sensor with the evaluation unit then represents the cheapest possibility, but is accompanied by high wiring expense. In addition, most of the cables require corresponding space within the device. The use of coupled buses, i.e., bus systems, therefore works with limited space conditions and a corresponding number of sensors. Such a bus system can operate according to the CANopen protocol and/or the PROFIBUS protocol. However, in principle, the use of other known communication protocols is also conceivable.

With reference to the aforementioned variants, a modification is proposed, in which a CAN data logger is provided, with which measured data can be stored. This CAN data logger can store measured data, for example, on a memory card. The CAN data logger can be configured so that it only sends error states to an optionally present programmable logic controller (PLC). Based on the recorded measured value history, establishment of certain trends is therefore also made possible.

In a particularly preferred modification of the device according to the invention, data can be transmitted with the data transmission device by radio waves. Data transmission devices, in other words, are provided that send the measured value data from the sensors of the gas pressure spring by radio to the evaluation unit. Such data transmission devices can be provided as an alternative or in addition to the aforementioned wired data transmission devices. If only data transmission devices operating by radio are provided, the wiring expense drops out. In addition, the space requirements within the device diminish. The gas pressure springs can also be used hermetically shielded, but measured value signals can be sent by radio to the evaluation unit.

It is preferred, with reference to the aforementioned variant, that data can be transmitted with the data transmission devices in the short-range GHz radio region, especially in the ISM band between 2.402 GHz and 2.480 GHz, especially according to the Bluetooth standard. Bluetooth is an industry standard for wireless radio linking of devices over a short distance. A wireless interface is therefore provided, via which especially mobile devices can communicate with each other. Cable connections between the devices are then replaced. Bluetooth devices generally transmit in the license-free ISM band (Industrial, Scientific and Medical Band) and may be operated worldwide registration-free.

In another embodiment of the device according to the invention, the evaluation unit has a memory for measured data. This memory can be implemented in the sensors of a gas pressure spring according to the invention, in addition to or as an alternative to a corresponding memory.

With particular preference, the evaluation unit has a programmable logic controller (PLC). The PLC can initially evaluate the transmitted measured data. If deviations from a stipulated target value are found, the PLC can act directly on the machine or tool that contains the monitored gas pressure springs. In this case, the stroke movement or frequency of the machine can be precisely monitored and adjusted. Since feedback of measured value data has an effect on the set point, a control behavior of the PLC is present. As an alternative, the PLC can also observe simple control tasks of the machine or tool without feedback of measured variables.

The programmable logic controller (PLC) can be integrated with the evaluation unit or separate from the evaluation unit.

If the programmable logic controller (PLC) forms its own component of the device according to the invention, it is preferred that AS interface bus, PROFIBUS, PROFINET, Interbus, Interbus-Safety, CAN and CANopen are set up between the evaluation device and the programmable logic controller (PLC) for data exchange of one or more of the bus systems.

The mentioned bus systems permit rapid and high-volume data exchange without incurring increased cabling expense.

Generally, a modification of the invention is particularly favored, in which several gas pressure spring's are connected on the pressure side. In this case, the common pressure value of several gas pressure springs can be determined with merely one sensor. Both the investment costs and wiring expense and the space requirements accompanying this are therefore reduced.

The aforementioned task is finally solved with reference to a method for monitoring of at least one physical measurement variable occurring in and/or on the gas pressure spring with the features of Claim 18. According to it, a method according to the invention has the following steps:
recording of the value of a physical measurement variable within and/or on the gas pressure spring with a sensor,
transmission of the measured value data to an evaluation unit, and
evaluation of the measured value data in the evaluation unit.

In the method according to the invention, a method is provided, with which comprehensibility and predictability of the use behavior of gas pressure springs are implemented as a function of the corresponding use conditions.

To avoid repetitions, with reference to the advantages of the method according to the invention and the preferred embodiments of the method according to the invention, the comments concerning the gas pressure spring according to the invention and the device according to the invention are referred to.

In performing the method according to the invention, one or more pressure and/or temperature values can be recorded.

The measured value data can be stored in the sensor and/or in the evaluation unit.

In another embodiment, the measured value data are transmitted from the sensor to the evaluation unit with one or more conductors, especially cables, and/or with one or more coupled buses.

The Profibus and/or the CANopen protocol can then be used, in which measured data are optionally stored in a CAN data logger.

In a particularly preferred modification of the method according to the invention, measured value data are transmitted from the sensor to the evaluation unit by radio, especially with short-range GHz radio waves, especially with radio waves in the ISM band between 2.402 GHz and 2.480 GHz, and especially according to the Bluetooth standard.

It is also particularly preferred to use a programmable logic controller (PLC) to monitor the measured values and optionally to control individual gas pressure springs and/or the entire tool and/or entire machine.

If the programmable logic controller (PLC) is separate from the evaluation unit, one or more of the protocols AS Interface Bus, PROFIBUS, PROFINET, Interbus, Interbus-Safety, CAN and CANopen are preferably used for data exchange between these devices.

In a particularly preferred modification of the method according to the invention, the number of completed stroke movements is detected and stored via the change in measured pressure within one or more gas pressure springs—especially by the evaluation unit. It is made possible by the method according to the invention to determine and maintain in particularly simple fashion, which is reliable in manipulation, the number of total stroke movements of a machine or tool. This is of particular interest in leased or rental machines.

With the method according to the invention, the length of the stroke movement and the frequency of machine or tool can be determined from the measured value data of the employed gas pressure springs. The method can therefore be used for error determination, analysis and elimination with particular advantage.

There are different possibilities for configuring and modifying the teachings of the present invention advantageously. For this purpose, on the one hand, the subsequent claims and, on the other hand, the subsequent explanation of three preferred practical examples of the device according to the invention are referred to. In conjunction with explanation of the preferred practical examples of the invention by means of the drawing, preferred embodiments and modifications of the gas pressure spring according to the invention, as well as the method according to the invention, are also explained in general with reference to the drawing. In the drawing

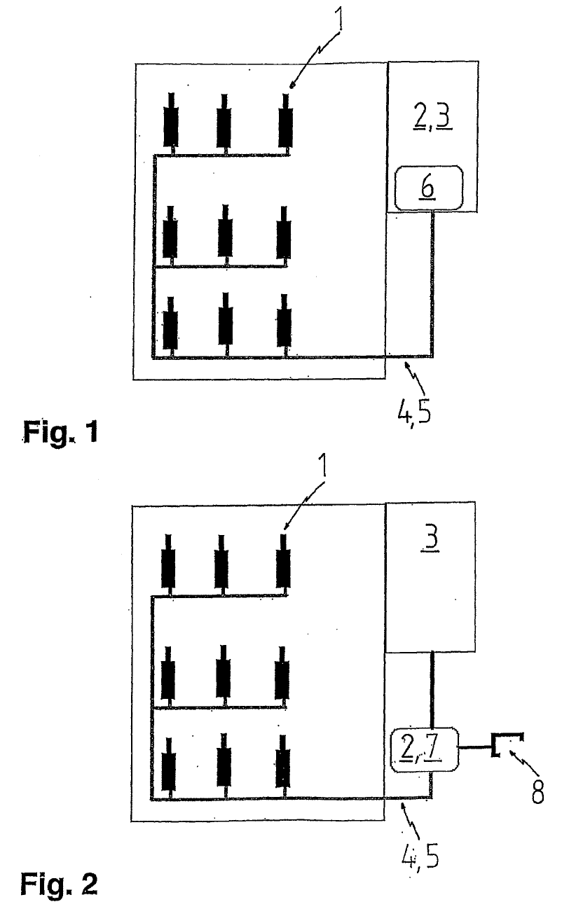

FIG. 1 shows a schematically depicted circuit diagram of a first variant of the device according to the invention, in which several gas pressure springs are connected to an evaluation unit designed as a programmable logic controller (PLC), in which the PLC has a CAN interface,

FIG. 2 shows a second variant of the device according to the invention, in which a CAN data logger is provided, and

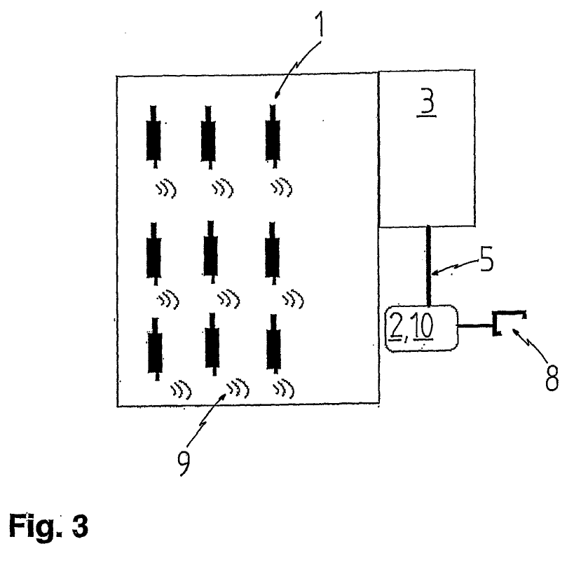

FIG. 3 shows a circuit diagram of a third, particularly preferred variant of the device according to the invention, in which the measured value data is transmitted by radio.

FIG. 1 shows a schematically depicted circuit diagram of a first preferred variant of the device according to the invention. A number of gas pressure springs 1 are arranged in a machine, in order to absorb stroke movements and to cushion and/or dampen them. Each gas pressure spring 1 is equipped with at least one sensor to monitor at least one physical measurement variable occurring in or on the gas pressure spring 1. These sensors are not shown in detail here.

Each gas pressure spring 1 here has at least one pressure temperature sensor or a combined pressure/temperature sensor. A gas pressure spring 1 can also have several pressure sensors distributed over its length, for example, to measure the pressure of the compressed gas before and after the piston. In addition, several temperature sensors can be provided, for example, within the gas pressure spring, to measure the temperature of the gas and on the surface of the gas pressure spring. The pressure medium in the present case is nitrogen.

To evaluate and further process the measured value data, an evaluation unit 2 is provided outside of the area, in which the gas pressure springs 1 are arranged. In the present practical example, the evaluation unit 2 is designed as a programmable logic controller (PLC) 3.

To transmit measured value data of the individual sensors to evaluation unit 2, data transmission devices 4 are provided. These data transmission devices 4 in the present example are designed as a bus 5, and especially as a CAN bus. The evaluation unit 2 has a CAN interface 6 to process the measured data.

Since the programmable logic controller (PLC) 3 has the CAN interface 6, storage and evaluation of the measured data can occur in the evaluation unit 2 formed by it.

FIG. 2 shows a circuit diagram of a second variant of the device according to the invention, which is borrowed from the variant of FIG. 1. Here, however, a CAN data logger 7 is situated in bus 5 between the gas pressure spring 1 and the programmable logic controller (PLC) 3. Consequently, in this variant, the CAN data logger 7 acts as evaluation unit 2. The CAN data logger 7 is configured so that it stores measured data on an SD memory card and only sends error information to the PLC 3. Because of this, independent monitoring is implemented. In addition, it is possible with the recorded measured value history to establish and transmit measured value trends.

The CAN data logger 7 is supplied electrical power by a voltage source 8.

FIG. 3 shows a schematic circuit diagram of a third particularly preferred variant of the device according to the invention. Here, the data transmission device is configured so that measured value data can be transferred from the gas pressure springs 1 to the evaluation unit 2 by radio waves 9. The radio waves 9 are indicated in this depicted, but the details of the data transmission devices arranged in the area of the sensors of the gas pressure springs 1 cannot be seen here. The data transmission devices communicate with an evaluation unit 2, which is designed here as a radio receiver 10. The evaluation unit 2 has an integrated microcontroller. Measured value data are transmitted between the gas pressure springs 1 and the radio receiver 10 in the short-rage GHz radio region, preferably according to the Bluetooth standard. The evaluation unit 2 also has a memory for measured data. It is supplied with electrical power from a voltage source 8.

A PLC 3 is also provided here separated from the evaluation unit 2. Different control tasks can be satisfied with PLC 3, especially concerning the device, in which the gas pressure springs 1 are arranged. If the gas pressure springs 1 are also controllable with reference to their spring/damping behavior, the PLC 3 can also act accordingly.

For communication between evaluation unit 2 and PLC 3, a bus 5 is provided. Here again, it can be a CAN or CANopen bus, or also a different known protocol.

The sensors of the gas pressure springs 1 in all the depicted variants have a power supply independent of line voltage. The greatest possible independence is achieved on this account.

With respect to additional advantageous embodiments of the gas pressure spring according to the invention, the device, as well as the method, the general part of the description and the general part of the description and the claims are referred to, to avoid repetitions.

Finally, it is explicitly pointed out that the practical examples just described of the device according to the invention only serve to explain the claimed teachings, but do not restrict them to the practical examples.

1.-26. (canceled)

27. A gas pressure spring, especially to absorb stroke movements in a tool or machine, having one or more sensors configured to monitor at least one physical measurement variable occurring within and/or on the gas pressure spring.

28. The gas pressure spring according to claim 27, wherein the sensors have a pressure sensor, a temperature sensor or a combined pressure/temperature sensor, in which the sensors can have a power supply independent of line voltage.

29. The gas pressure spring according to claim 27, wherein the sensors have a memory for measured data.

30. A device for monitoring at least one physical measurement variable occurring within and/or on a gas pressure spring, said device comprising:
one or more gas pressure springs according to claim 27;
one or more evaluation units; and
one or more data transmission devices configured to transmit data between the sensors and the evaluation unit.

31. The device according to claim 30, wherein the evaluation unit is a microcontroller and/or
wherein the data transmission device has one or more conductors, especially cables, and/or one or more coupled buses, in which
the data transmission device can have a bus according to the CANopen protocol and/or according to the Profibus protocol, and in which
a CAN data logger can be provided, with which measured data can be stored.

32. The device according to claim 30, wherein data can be transmitted with radio waves with the data transmission devices, in particular in which
data can be transmitted with the data transmission devices in the short-range GHz radio wave region, especially in the ISM band between 2.402 GHz and 2.480 GHz, and especially according to the Bluetooth standard.

33. The device according to claim 30, wherein the evaluation unit has a memory for measured data and/or
a programmable logic controller (PLC) or
a programmable logic controller (PLC) is provided separate from the evaluation unit, in which
one or more of the bus systems AS interface bus, PROFIBUS, PROFINET, Interbus, Interbus-Safety, CAN and CANopen can be set up for data exchange between the evaluation unit and the programmable logic controller (PLC).

34. The device according to claim 30, wherein several gas pressure springs are connected on the pressure side.

35. A method for monitoring at least one physical measurement variable occurring within and/or on a gas pressure spring, said method comprising:
recording the value of a physical measurement variable within and/or or on the gas pressure spring with a sensor;
transmitting the measured value data to an evaluation unit; and
evaluating the measured value data in the evaluation unit.

36. The method according to claim 35, wherein one or more values of the pressure and/or temperature are recorded and/or
wherein measured value data are stored in the sensor and/or in the evaluation unit.

37. The method according to claim 35, wherein measured value data are transmitted from the sensor to the evaluation unit with one or more conductors, especially cables, and/or with one or more coupled buses, in which
the Profibus and/or CANopen protocol is used, and in which measured data are optionally stored in a CAN data logger.

38. The method according to claim 35, wherein measured value data are transmitted from the sensors to the evaluation unit by radio, especially with short-range GHz radio waves, especially with radio waves in the ISM band between 2.402 GHz and 2.480 GHZ, and especially according to the Bluetooth standard.

39. The method according to claim 36, wherein a programmable logic controller (PLC) is used to monitor the measured values and optionally for control.

40. The method according to claim 36, wherein for data exchange between the evaluation unit and the programmable logic controller (PLC), one or more of the protocols AS interface bus, PROFIBUS, PROFINET, Interbus, Interbus-Safety, CAN and CANopen is used.

41. The method according to claim 36, wherein the number of completed stroke movements is detected and stored via the change in measured pressure within the gas pressure spring, in particular by the evaluation unit.
